(19) United States
(12) Patent Application Publication
(10) Pub. No.: US 2007/0190837 A1
(43) Pub. Date: Aug. 16, 2007

(54) Computer with a detachable case

(75) Inventors: Lin-Hsu Chiang, Taipei City (TW); Kuan-Yen Lee, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/648,621

(22) Filed: Jan. 3, 2007

(30) Foreign Application Priority Data
Feb. 16, 2006 (TW) 095105241

(51) Int. Cl. H01R 3/08

(52) U.S. Cl. 439/179

(57) ABSTRACT

A computer with a detachable case is disclosed to include a second case member abutted to a first case member, a rotating member pivoted to the second case member and rotatable between a first position and a second position. When the rotating member is on the second position, a spring member of the second case member is adapted to impart a pulling force to the rotating member to pull the rotating member from the second position to the first position. A second retaining portion of the second case member is forced into engagement with the first retaining portion of the first case member when the rotating member is turned to the first position. The second retaining portion is disengaged from the first retaining portion when the rotating member is turned to the second position.

### BACKGROUND OF THE INVENTION

1. Field of the Invention

The present invention relates to a computer and more specifically, to a computer with a detachable case.

2. Description of Related Art

When repairing or assembling the internal component parts of a computer, the user or maintenance engineer must detach the case of the computer so that the repair or assembly work can be performed.

For example, when repairing or mounting a CPU on a motherboard in a computer, the user or maintenance engineer must detach one or a number of the case panels of the case. After finish of the repair or maintenance work, the user or maintenance engineer must reinstall the detached case panels again.

According to conventional designs, tie screws are commonly used to fasten the case panels to the body of the computer. When mounting or dismounting the screws, the user or maintenance engineer needs to use a screwdriver. This mounting/dismounting procedure requires much time and effort. Further, the use of the tie screws greatly increases the number of parts.

Recently, thumb screws (hand screws) are common used to substitute for tie screws for fastening case panels to the body of a computer. The user or maintenance engineer can directly mount/dismount thumb screws with the hands without a screwdriver. However, it still takes much time and labor to rotate each thumb screw to lock/unlock the case panels.

### SUMMARY OF THE INVENTION

The present invention has been accomplished under the circumstances in view. The detachable case member mounting structure in accordance with the present invention comprises a first case member, and a second case member. The first case member has at least one retaining device. The second case member has at least one retaining device and is abutted to the first case member. Further, the second case member has connected thereto a rotating member and at least one spring member. The rotating member is pivoted to the second case member and rotatable relative to the second case member between a first position and a second position. The at least one spring member is adapted to impart a pulling force to the rotating member to pull the rotating member from the second position to the first position. The at least one retaining device of the second case member is respectively forced into engagement with the at least one retaining device of the first case member when the rotating member is turned to the first position. On the contrary, when the rotating member is turned to the second position, the at least one retaining device of the second case member is respectively disengaged from the at least one retaining device of the first case member.

Therefore, by means of the aforesaid structural design, the at least one retaining device of the first case member and the at least one retaining device of the second case member can be respectively engaged together or disengaged from each other to further lock/unlock the first case member and the second case member, i.e., the simple design of the detachable device case mounting structure saves much component parts and allows quick mounting/dismounting of the device case with less effort.

The second case member further has an opening. The rotating member further has a protruding portion inserted through the opening of the second case member and movable with the rotating member between a third position and a fourth position. The protruding portion is in the third position when the rotating member is in the first position. The protruding portion is in the fourth position when the rotating member is in the second position. When the protruding portion is in the fourth position, the protruding portion touches the opening of the second case member. When the protruding portion is in the fourth position, the protruding portion pushes the second case member away from the first case member.

The second case member further has at least one slot. The at least one retaining device of the second case member each has at least one part respectively inserted through the at least one slot. The at least one slot is respectively disposed in communication with the at least one retaining device of the first case member when the at least one retaining device of the second case member is respectively engaged into the at least one retaining device of the first case member.

Further, a button is mounted on the first case member. The button has at least one part thereof inserted through the first case member. When the button is pressed, the button is forced into contact with the rotating member. The rotating member has a handle for stopping against the button.

### BRIEF DESCRIPTION OF THE DRAWINGS

FIG. 1 is a schematic drawing showing an application example of a detachable device case mounting structure in accordance with a first embodiment of the present invention.

FIG. 2 is an exploded view of a detachable device case mounting structure in accordance with the first embodiment of the present invention.

FIG. 3 is an assembly view of the detachable device case mounting structure in accordance with the first embodiment of the present invention.

FIG. 4 is a schematic drawing showing the action of the detachable device case mounting structure in accordance with the first embodiment of the present invention (I).

FIG. 5 is a schematic drawing showing the action of the detachable device case mounting structure in accordance with the first embodiment of the present invention (II).

FIG. 6 is an exploded view of a detachable device case mounting structure in accordance with a second embodiment of the present invention.

FIG. 7 is an assembly view of the detachable device case mounting structure in accordance with the second embodiment of the present invention.

FIG. 8 is a schematic drawing showing the action of the detachable device case mounting structure in accordance with the second embodiment of the present invention (I).

FIG. 9 is a schematic drawing showing the action of the detachable device case mounting structure in accordance with the second embodiment of the present invention (II).

FIG. 10 is an exploded view of a detachable device case mounting structure in accordance with a third embodiment of the present invention.

FIG. 11 is an assembly view of the detachable device case mounting structure in accordance with the third embodiment of the present invention.

FIG. 12 is a schematic drawing showing the action of the detachable device case mounting structure in accordance with the third embodiment of the present invention (I).

FIG. 13 is a schematic drawing showing the action of the detachable device case mounting structure in accordance with the third embodiment of the present invention (II).

### DETAILED DESCRIPTION OF THE PREFERRED EMBODIMENT

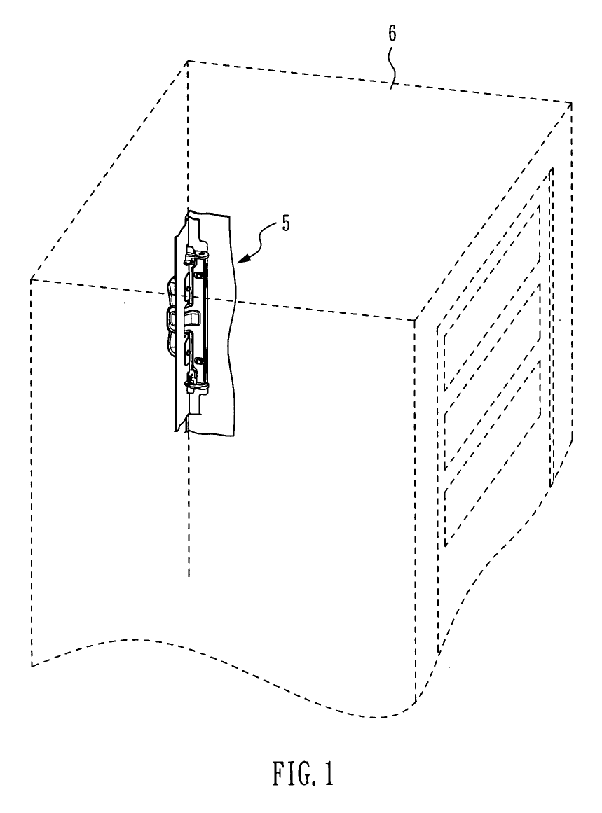

Referring to FIG. 1, a detachable device case mounting structure 5 in accordance with a first embodiment of the present invention is shown used in a computer 6.

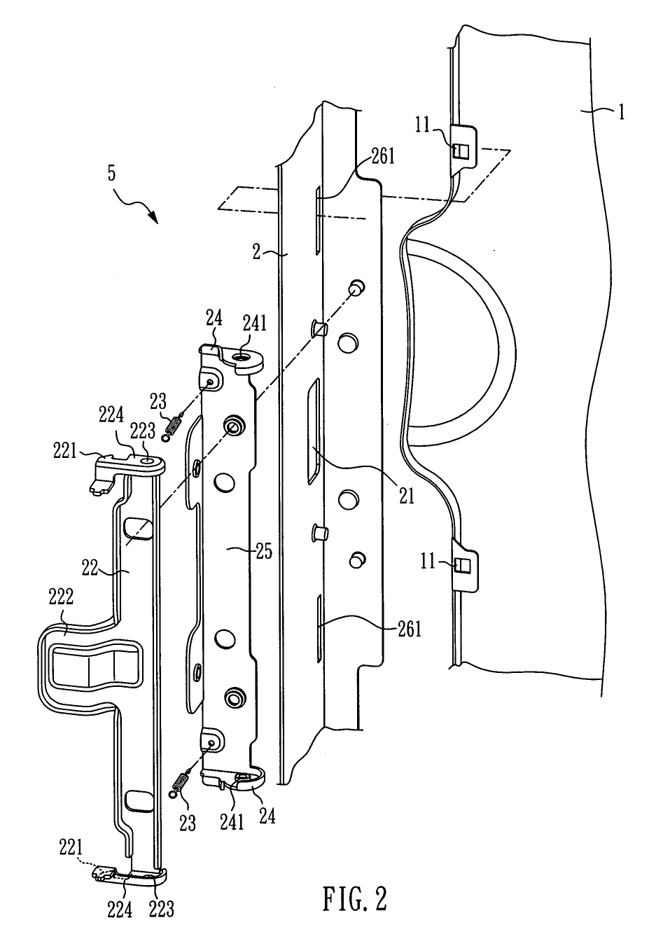

Referring to FIG. 2 and FIG. 1 again, the detachable device case mounting structure 5 comprises a first case member 1, and a second case member 2. The first case member 1 includes two female retaining portions 11. In this embodiment, the two female retaining portions 11 have retaining holes and are formed on the first case member 1 at two sides.

The second case member 2 is abutted to the first case member 1, including mounted thereon a rotating member 22 and two spring members 23. The rotating member 22 is pivoted to the inside wall of the second case member 2, and rotatable relative to the second case member 2 between a first position and a second position. The two spring members 23 are respectively connected between the second case member 2 and the rotating member 22.

In this embodiment, the second case member 2 further includes a plate 25 fixedly mounted on the inside wall thereof. The rotating member 22 is pivoted to the plate 25. The plate 25 has two pivots 24 respectively extending from two distal ends thereof at right angles and arranged in parallel, and two pivot shafts 241 respectively perpendicularly extending from the pivots 24 and aimed at each other. The rotating member 22 has two pivot holes 223 disposed at two distal ends thereof and respectively pivotally coupled to the pivot shafts 241 of the pivots 24. Therefore, the rotating member 22 can rotate relative to the plate 25, i.e., the rotating member 22 can rotate relative to the second case member 2.

In this embodiment, the two spring members 23 connect the rotating member 22 to the second case member 2, i.e., the two spring members 23 are respectively connected to the plate 25 of the second case member 2. The spring force of the spring members 23 automatically returns the rotating member 22 after the rotating member 22 having been rotated. It should be noted that, in other embodiment, the two spring members 23 may be torsional springs.

The rotating member 22 further includes two connection arms 224 respectively extending from the two distal ends thereof. The pivot holes 223 of the rotating member 22 are respectively formed on the connection arms 224. The rotating member 22 further includes a middle protruding portion 222. The second case member 2 further includes an opening 21. The protruding portion 222 is moved with the rotating member 22 between a third position and a fourth position, i.e., when the rotating member 22 is in the first position, the protruding portion 222 is in the third position; when the rotating member 22 is in the first position, the protruding portion 222 is in the fourth position. When in the fourth position, the protruding portion 222 touches the opening 21 and pushes the second case member 2 apart from the first case member 1.

In this embodiment, the second case member 2 further includes two slots 261 symmetrically spaced from the opening 21 at two sides. The rotating member 22 further includes two male retaining components 221 respectively extended from the connection arms 224 for engaging the slots 261 of the second case member 2. When the male retaining components 221 are respectively engaged into the slots 261 of the second case member 2, the slots 261 are respectively kept in communication with the retaining components 11.

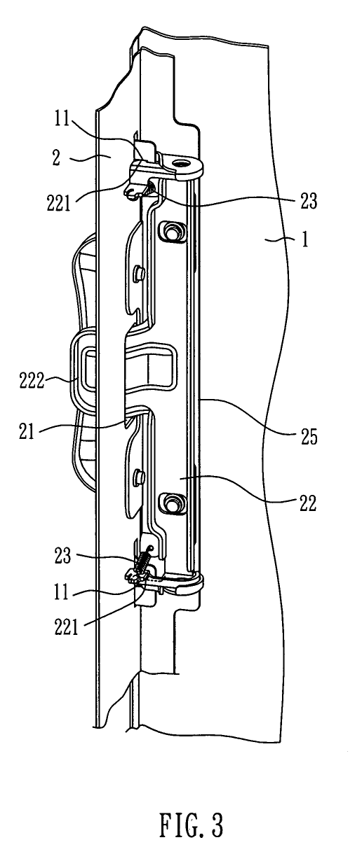

The engagement/disengagement operation between the first case member 1 and the second case member 2 is described hereinafter with reference to FIGS. 3˜5 and FIG. 2 again.

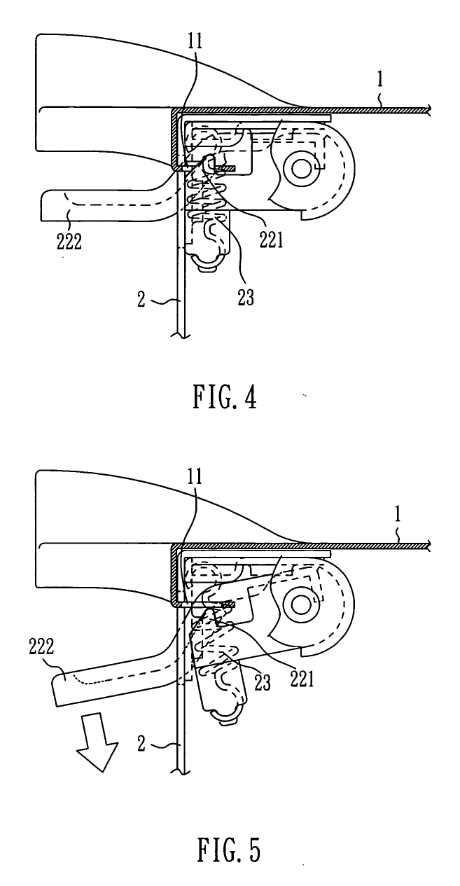

In this embodiment, the male retaining components 221 are hooks. When the rotating member 22 is in the first position, i.e., when the protruding portion 222 is in the third position (see FIG. 4), the male retaining components 221 each have at least a part respectively inserted through the slots 261 and engaged into the female retaining portions 11 to lock the second case member 2 to the first case member 1.

On the contrary, when pressed the protruding portion 222 to rotate the rotating member 22 from the first position to the second position, the protruding portion 222 is moved to the fourth position (see FIG. 5). At this time, the male retaining components 221 are respectively disengaged from the female retaining portions 11, and therefore the first case member 1 and the second case member 2 are disconnected.

Therefore, by means of the aforesaid structural design, the female retaining portions 11 and the male retaining components 221 can be engaged together or disengaged from each other to further lock/unlock the first case member 1 and the second case member 2, i.e., the simple design of the detachable device case mounting structure saves much component parts and allows quick mounting/dismounting of the device case with less effort.

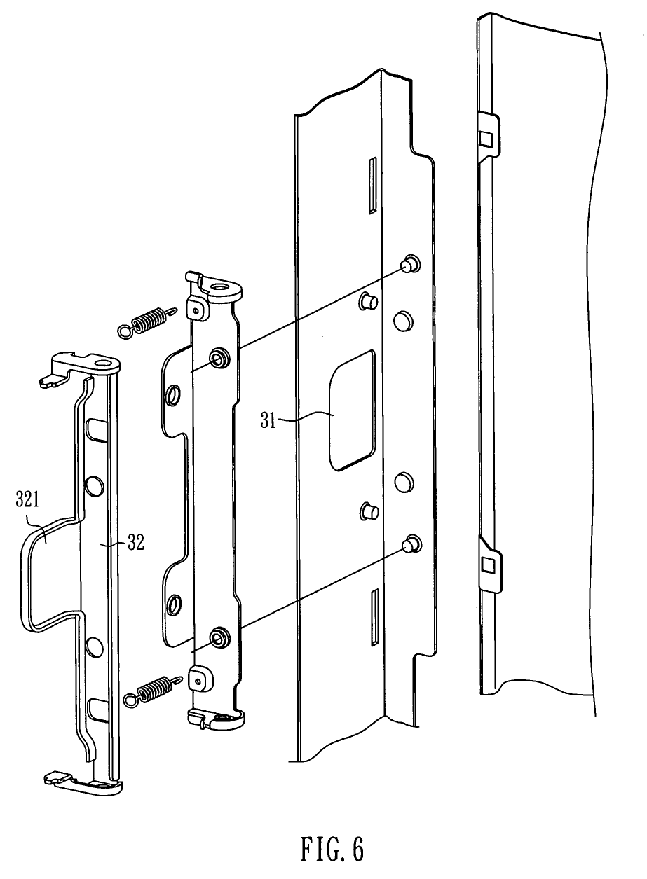

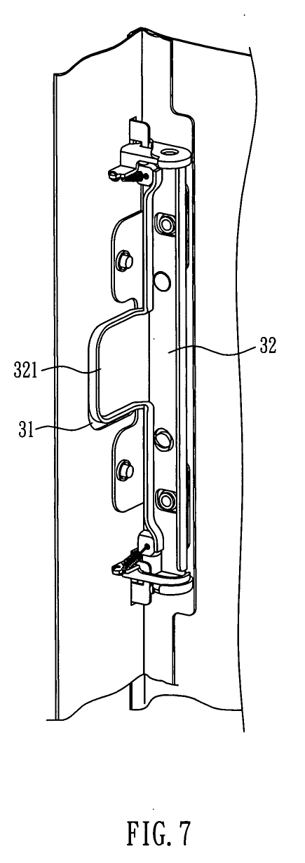

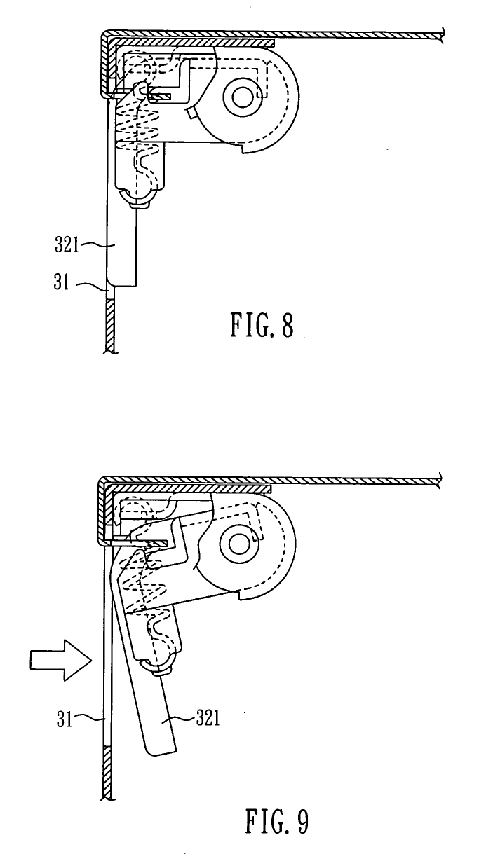

FIG. 6 is an exploded view of a detachable device case mounting structure in accordance with a second embodiment of the present invention. FIG. 7 is an assembly view of the detachable device case mounting structure in accordance with the second embodiment of the present invention. FIG. 8 is a schematic drawing showing the action of the detachable device case mounting structure in accordance with the second embodiment of the present invention (I). FIG. 9 is a schematic drawing showing the action of the detachable device case mounting structure in accordance with the second embodiment of the present invention (II). This second embodiment is substantially similar to the aforesaid first embodiment with the exception that the protruding portion 321 (of the rotating member) and the opening 31 (of the second case member) are arranged on the same plane. This embodiment achieves the same effect.

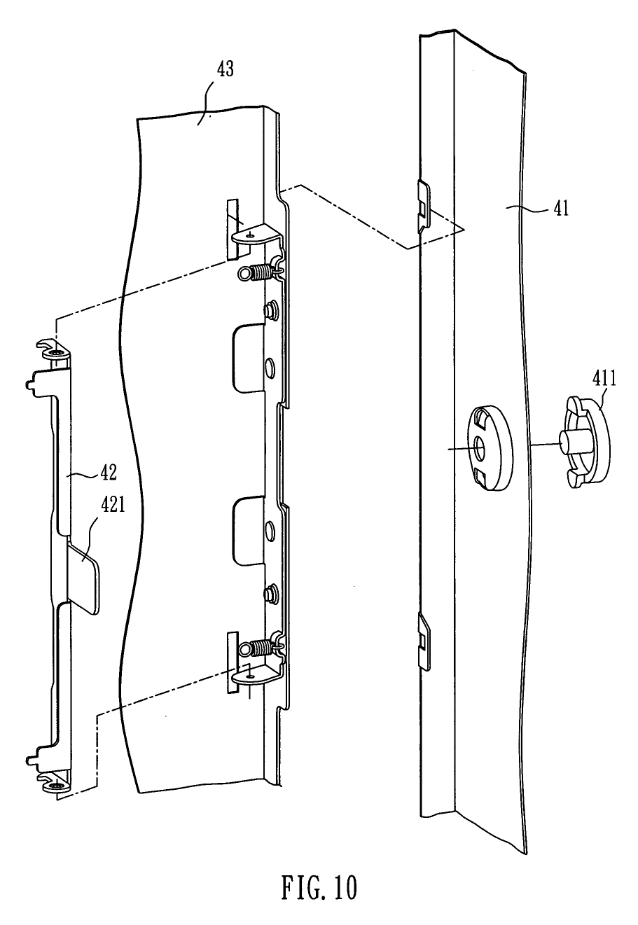

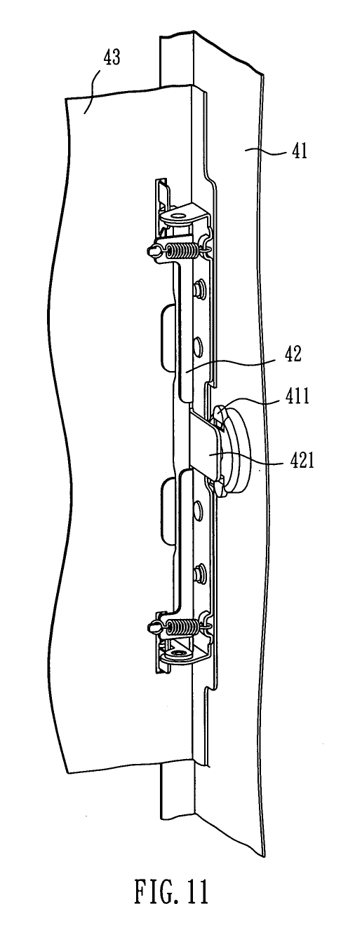

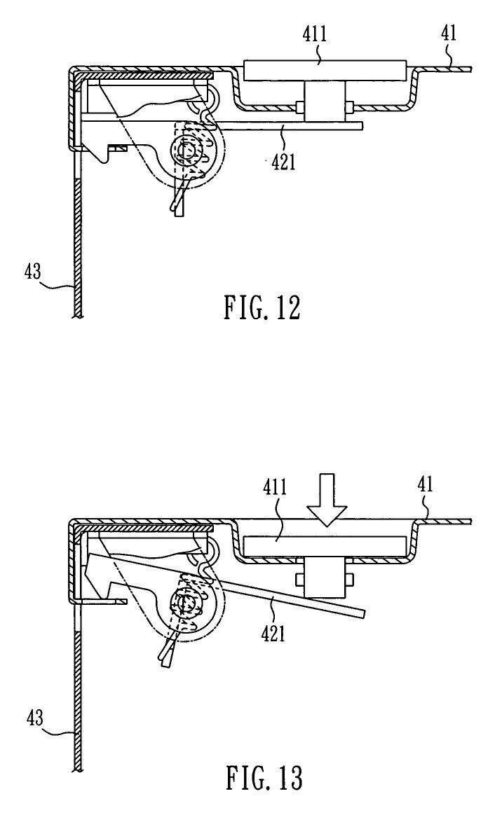

FIG. 10 is an exploded view of a detachable device case mounting structure in accordance with a third embodiment of the present invention. FIG. 11 is an assembly view of the detachable device case mounting structure in accordance with the third embodiment of the present invention. FIG. 12 is a schematic drawing showing the action of the detachable device case mounting structure in accordance with the third embodiment of the present invention (I). FIG. 13 is a schematic drawing showing the action of the detachable device case mounting structure in accordance with the third embodiment of the present invention (II). According to this third embodiment, a button 411 is mounted on the first case member 41 and has a part inserted through the first case member 41; the rotating member 42 has a handle 421 stopped against the button 411. When pressed the button 411, the handle 421 is forced to rotate the rotating member 42, thereby causing the second case member 43 to be disconnected from the first case member 41. This design achieves the same effect as the aforesaid first and second embodiments.

Although the present invention has been explained in relation to its preferred embodiments, it is to be understood that many other possible modifications and variations can be made without departing from the spirit and scope of the invention as hereinafter claimed.

What is claimed is:

1. A computer with a detachable case comprising:
a first case member, having at least one first retaining portion; and
a second case member abutted to the first case member and including a rotating member and at least one spring member, the rotating member being pivoted to the second case member and rotatable relative to the second case member between a first position and a second position;
the spring member being adapted to impart a pulling force to the rotating member to pull the rotating member from the second position to the first position when the rotating member is on the second position;
wherein the rotating member further comprises a second retaining portion, the second retaining portion being forced into engagement with the first retaining portion when the rotating member is turned to the first position, the second retaining portion being disengaged from the first retaining portion when the rotating member is turned to the second position.

2. The computer as claimed in claim 1, wherein the rotating member further includes at least one connection arm; the second retaining portion is placed on the connection arm.

3. The computer as claimed in claim 1, wherein the second case member has an opening; the rotating member further includes a protruding portion inserted through the opening of the second case member and movable with the rotating member between a third position and a fourth position, the protruding portion being in the third position when the rotating member is in the first position, the protruding portion of the rotating member is in the fourth position when the rotating member is in the second position.

4. The computer as claimed in claim 3, wherein when the protruding portion is in the fourth position, the protruding portion touches the opening of the second case member.

5. The computer as claimed in claim 3, wherein when the protruding portion is in the fourth position, the protruding portion pushes the second case member away from the first case member.

6. The computer as claimed in claim 1, wherein the first retaining portion is a retaining hole; the second retaining portion is a hook.

7. The computer as claimed in claim 1, wherein the second case member has at least one slot; the second retaining portion has at least one part respectively inserted through the slot; the slot is respectively disposed in communication with the first retaining portion when the second retaining portion is respectively engaged into the first retaining portion.

8. The computer as claimed in claim 1, wherein the spring member each is connected between the rotating member and the second case member.

9. The computer as claimed in claim 1, further comprising a button mounted on the first case member, the button having at least one part thereof inserted through the first case member for contacting the rotating member when the button is pressed by an external force.

10. The computer as claimed in claim 9, wherein the rotating member has a handle for stopping against the button.
